(19) United States
(12) Patent Application Publication
(10) Pub. No.: US 2013/0057978 A1
(43) Pub. Date: Mar. 7, 2013

(54) MAGNETIC RECORDING REPRODUCING APPARATUS AND MAGNETIC RECORDING MEDIUM

(71) Applicants: Toshihiko Sakai, Osaka-shi (JP); Yoshiteru Murakami, Osaka-shi (JP)

(72) Inventors: Toshihiko Sakai, Osaka-shi (JP); Yoshiteru Murakami, Osaka-shi (JP)

(73) Assignee: Sharp Kabushiki Kaisha, Osaka (JP)

(21) Appl. No.: 13/587,094

(22) Filed: Aug. 16, 2012

(30) Foreign Application Priority Data
Sep. 7, 2011 (JP) 2011-194646

(51) Int. Cl. G11B 21/02; G11B 5/82

(52) U.S. Cl. 360/75; 360/135; G9B/21.003; G9B/5.293

(57) ABSTRACT

In an information recording area of a disc-shaped magnetic recording medium, recording columns adjacent to each other relative to a radial direction are formed so as to partially overlap with each other in the radial direction. Each recording column has an overlapping portion which partially overlaps with either of the adjacent recording columns in the radial direction, and a non-overlapping portion which does not overlap with any of the recording columns in the radial direction.

### CROSS REFERENCE TO RELATED APPLICATION

The present application claims priority from Japanese Patent Application No. 2011-194646, which was filed on Sep. 7, 2011, the disclosure of which is herein incorporated by reference in its entirety.

### BACKGROUND OF THE INVENTION

1. Field of the Invention

The present invention relates to a magnetic recording reproducing apparatus and a magnetic recording medium, which adopt a Shingle recording technology and capable of densely recording information.

2. Description of the Related Art

Improvement in high quality pictures and images causes a considerable increase in the volume of information handled by a user. For the purpose of realizing a larger capacity magnetic recording apparatus so-called HDD (Hard Disk Drive), approaches for increasing the surface recording density have been discussed. One high-density magnetic recording technology that seems to be promising is a Shingle recording technique which is disclosed in Japanese Unexamined Patent Publication No. 2011-8881 (Tokukai 2011-8881) for example, in which recording is performed so that a recording column currently being recorded partially overlap with another recording column adjacent in a track width direction, the other recording column having been subjected to immediately previous recording.

In general, the pitch of tracks formed on a magnetic recording medium is a several times greater than a shortest mark formed. However, Shingle recording technique performs recording so as to partially overlap with an adjacent recording column having been subjected to immediately previous recording. Therefore, the pitch of tracks to be formed at the end is reduced to a pitch which is approximately the same as the shortest mark length. In other words, recording is performed so as to partially overwrite the adjacent recording column having been subjected to immediately previous recording. This increases the number of tracks per unit length to several times more, and makes it possible a significant improvement in the recording density.

### SUMMARY OF THE INVENTION

However, with the apparatus of the Japanese Unexamined Patent Publication No. 8881/2011 (Tokukai 2011-8881), rewriting of a recording column necessitates rewriting of all the subsequently-formed recording columns. This may lead to a lower substantial recording rate (the information amount of recording column rewritten/time required for rewriting recording columns to be rewritten and not rewriting the information of the other recording columns). This is elaborated with reference to FIG. 7A to FIG. 7D.

FIG. 7A shows a plurality of recording columns on a magnetic recording medium, each of which is formed so as to partially overlap with a recording column adjacent in the track width direction (radial direction of the recording medium). Specifically, throughout the entire radial direction, each of the recording columns forms an overlapping portion in which the recording column is overlapped with either of two adjacent recording columns in a radial direction. In FIG. 7A to FIG. 7D, the boarder lines and the center lines of the tracks obtained at the end (tracks at the time of reproducing) are indicated by dotted lines and dashed lines, respectively. FIG. 7B shows a state after recording a recording column for forming a track Tr102′ for rewriting the track Tr102 shown in FIG. 7A.

The recording column for forming a track Tr101 is formed prior to formation of the recording column for forming a track Tr102. Therefore, the information on the track Tr101 remains without being rewritten. On the other hand, a track Tr103 is overwritten with the recording column for forming the Tr102′, and an attempt to reproduce the track Tr103 under such a condition will result in a reproduction error. Therefore, the recording column for forming the track Tr103 formed after the formation of the recording column for forming the track Tr102 needs to be overwritten with a recording column for forming the track Tr103′ with information identical to that on the recording column for forming the track Tr103. FIG. 7C shows a schematic view of the state after overwriting with the recording column for forming the track Tr103′. All the recording columns formed after the formation of the recording column for forming the track Tr102 need to be successively overwritten, in the similar manner. FIG. 7D schematically shows a state in which all the recording columns formed after the recording column for forming the track Tr102 are overwritten.

As described, rewriting only the track Tr102 requires, in total, a time for forming the recording column for forming the track Tr102′, and a time for overwriting all the recording columns formed after the recording column for forming the track Tr102. This requires a rewriting time which is several times longer than the prior recording technique.

It is therefore an object of the present invention to provide a magnetic recording reproducing apparatus and a magnetic recording medium, in which a decrease in the substantial recording rate for rewriting operation is prevented and a reproduction error hardly occurs, in cases of adopting a Shingle recording technique which allows a densely recording.

A magnetic recording reproducing apparatus of the present invention includes: a disc-shaped magnetic recording medium having thereon information recording areas; a magnetic recording element configured to perform information recording, by applying a magnetic field to the magnetic recording medium to form recording columns extending in a circumferential direction of the magnetic recording medium; a magnetic reproducing element, which performs information reproduction by detecting leaked magnetic field from the magnetic recording medium; a moving mechanism configured to move the relative position of the magnetic recording medium to the magnetic recording element and the magnetic reproducing element, in the circumferential direction and a radial direction of the magnetic recording medium; and a magnetic recording element control unit configured to control the magnetic recording element and the moving mechanism so that, in the information recording area, recording columns adjacent to each other relative to the radial direction are overlapped with each other in the radial direction. The magnetic recording element control unit performs control so that each of the recording columns has an overlapping portion which partially overlaps with either of the adjacent recording columns in the radial direction, and a non-overlapping portion which does not overlap with any of the recording columns in the radial direction.

A magnetic recording medium of the present invention is a disc-shaped magnetic recording medium comprising information recording areas each having a plurality of recording columns extending in a circumferential direction. Each of the recording columns has an overlapping portion which partially overlaps with either of the adjacent recording columns in a radial direction, and a non-overlapping portion which does not overlap with any of the recording columns in the radial direction.

### BRIEF DESCRIPTION OF THE DRAWINGS

Other and further objects, features and advantages of the invention will appear more fully from the following description taken in connection with the accompanying drawings in which:

FIG. 1A and FIG. 1B schematically show a plurality of recording columns formed on a magnetic recording medium related to the first embodiment, according to the present invention.

FIG. 2 shows a schematic configuration of a magnetic recording reproducing apparatus which performs recording/reproducing with respect to the magnetic recording medium of FIG. 1A and FIG. 1B.

FIG. 3 shows a schematic configuration of a recording reproducing head of the magnetic recording reproducing apparatus shown in FIG. 2.

FIG. 4A and FIG. 4B schematically show a plurality of recording columns formed on a magnetic recording medium related to a modification of the first embodiment, according to the present invention.

FIG. 5 schematically shows a plurality of recording columns and a tracking pattern formed on a magnetic recording medium related to the second embodiment, according to the present invention.

FIG. 6 is a partially enlarged view of the plurality of recording columns shown in FIG. 5.

FIG. 7A, FIG. 7B, FIG. 7C, and FIG. 7D schematically show a plurality of recording columns formed on a magnetic recording medium related to a prior art.

### DESCRIPTION OF THE PREFERRED EMBODIMENTS

### First Embodiment

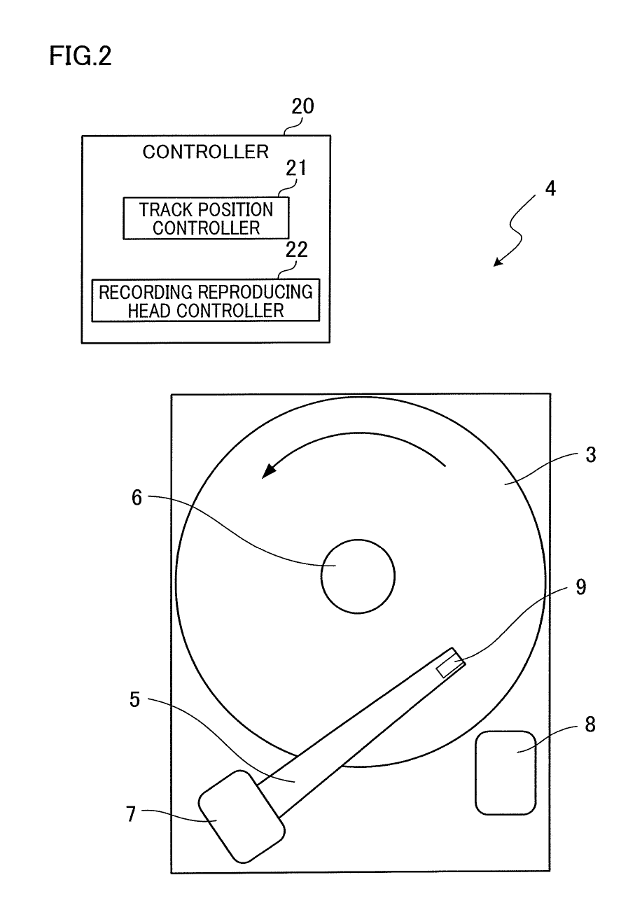

The following describes a first embodiment of present invention. As shown in FIG. 2, a magnetic recording reproducing apparatus 4 of the present embodiment includes: a suspension 5, a spindle 6, a voice coil motor 7, a ramp mechanism 8, a recording reproducing head 9, and a controller 20 which controls the suspension 5, the voice coil motor 7, and the recording reproducing head 9. Note that FIG. 2 shows the magnetic recording reproducing apparatus 4 with a disc-shaped magnetic recording medium 3. The structure of the magnetic recording medium 3, the recording and reproduction method of the magnetic recording medium 3 by the magnetic recording reproducing apparatus 4, and the details of the controller 20 are explained later.

The suspension 5 has one end portion fixed to the voice coil motor 7 and another end portion far from the voice coil motor 7 having a recording reproducing head 9 which applies a magnetic field to the magnetic recording medium 3. The spindle 6 rotates the magnetic recording medium 3 counterclockwise (the direction of the arrow shown in FIG. 2), when the magnetic recording reproducing apparatus 4 records or reproduces information to or from the magnetic recording medium 3. At the center portion of the magnetic recording medium 3 is formed a hole to which the spindle 6 is fit. The voice coil motor 7 moves the suspension 5 so that the recording reproducing head 9 attached to the suspension 5 moves above the magnetic recording medium 3 in radial directions (cross-track directions) of the magnetic recording medium 3. In other words, the recording reproducing head 9 is capable of changing its position relative to the radial directions of the magnetic recording medium 3, according to the movement of the voice coil motor 7. The ramp mechanism 8 is for setting back the recording reproducing head 9 when no recording or reproduction of information is performed to or from the magnetic recording medium 3. In other words, when no recording or reproduction of information is performed, the recording reproducing head 9 is fixed to the ramp mechanism 8.

Note that, the spindle 6, a not-shown motor (relating to movement in the circumferential direction) which rotates the spindle 6, the suspension 5 (related to movement in the radial direction), and the voice coil motor 7 (related to movement in the radial direction) structure a “moving mechanism” of the present embodiment.

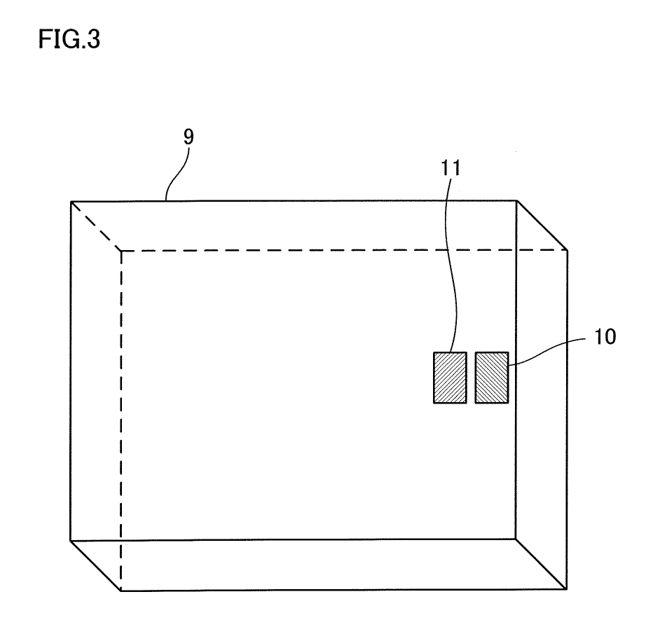

The recording reproducing head 9 is for recording and reproducing magnetic information. Specifically as shown in FIG. 3, the surface of the recording reproducing head 9 close to the magnetic recording medium 3 (i.e., the surface facing the magnetic recording medium 3) is provided with a magnetic recording element 10 and a magnetic reproducing element 11 for a vertical magnetic recording medium.

The magnetic recording element 10, when recording information to the magnetic recording medium 3, applies a magnetic field of a recordable intensity to the magnetic recording medium 3, thereby forming a recording column extended in a circumferential direction (track direction) of the magnetic recording medium 3. This way, for example, the direction of magnetization on the magnetic recording medium 3 is determined. The magnetic reproducing element reads a magnetization pattern by detecting a leaked magnetic field from the magnetic recording medium 3, thereby reproducing the information. Note that the positional relation between the magnetic recording element 10 and the magnetic reproducing element 11 relative to the circumferential direction when viewed from the magnetic recording medium 3 is such that, when the recording reproducing head 9 passes any given position of the magnetic recording medium 3, the magnetic reproducing element 11 passes that position first, followed by the magnetic recording element 10.

As described, the magnetic recording reproducing apparatus 4 is capable of performing recording and reproduction to a predetermined position of the magnetic recording medium 3, with the operations of the spindle 6 and the suspension 5, and by controlling application of the magnetic field by the recording reproducing head 9. In other words, the magnetic recording reproducing apparatus 4 includes a controller 20 which performs a predetermined computing process for controlling various functions of the suspension 5, spindle 6, or the like. For example, the controller 20 is realized by a CPU (Central Processing Unit) or the like. As shown in FIG. 2, the controller 20 includes: a track position controller 21 which controls the suspension 5 and the voice coil motor 7 thus enabling tracking of a predetermined track (the track to be followed and subjected to recording or reproduction); a recording reproducing head controller 22 which controls the recording reproducing head 9 to record or reproduce information to/from the magnetic recording medium 3 at a predetermined timing.

Next, the following describes a magnetic recording medium 3 included in the magnetic recording reproducing apparatus 4. The magnetic recording medium 3 of the present embodiment is manufactured by: forming a magnetic layer on a glass substrate; polishing the surface to smoothen the same; and applying a lubricant. The material (magnetic layer) which forms a magnetic recording part may be, for example, Co, Pt, Fe, Ni, Cr, Mn, or an alloy of any of these metals. Examples of the above alloy include, for example, CoPt, SmCo, CoCr, and TbFeCo alloy. Further, in the present embodiment, the magnetic recording surface is formed only on one side of the magnetic recording medium 3. However, the present invention is not limited to this, and the magnetic recording surface may be formed on both sides of the magnetic recording medium 3. In such a case, the above mentioned processes of the manufacturing method are carried out on both sides of the magnetic recording medium 3. Note that application of the lubricant on the magnetic recording surfaces on both sides of the magnetic recording medium 3 may be carried out at the same time.

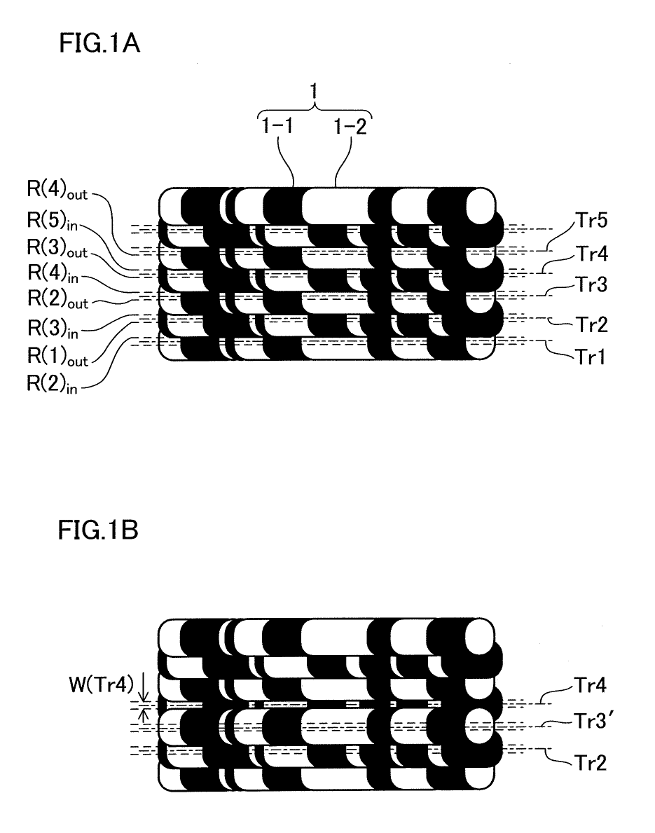

Next, the following describes control performed by the controller 20. As mentioned hereinabove, the controller 20 controls the suspension 5, the voice coil motor 7, and the recording reproducing head 9 to form on the magnetic recording medium 3 a plurality of recording columns shown in FIG. 1A. Since the rotational direction of the magnetic recording medium 3 is from the right to left (arrow direction of FIG. 2), each of the recording columns is formed from the left to the right side of the figure. For example, the magnetic recording medium 3 is a type of medium on which information is recorded by magnetizing the medium in a direction perpendicular to its in-plane direction. In the present embodiment, a magnetization pattern 1-1 (positive polarity) which is in a direction from the viewer of the figure towards the figure is shown in black, and a magnetization pattern 1-2 (negative polarity) which is in a direction from the figure towards the viewer of the figure is shown in white. These patterns are simply referred to as magnetization pattern 1, unless their polarities need to be distinguished.

As shown in FIG. 1A, the controller 20 performs control to form, on the magnetic recording medium 3, a plurality of recording columns (where radial positions of the inner and outer circumferential edges of an n-th recording column are R(n)ᵢₙ and R(n)ₒᵤₜ, respectively, the width of the column is R(n)ₒᵤₜ−R(n)ᵢₙ) each extending in the circumferential direction of the magnetic recording medium 3, sequentially in a radial direction from one side (from the bottom of the figure) to the other side (upper portion of the figure) of the magnetic recording medium 3. The recording columns formed on the magnetic recording medium are formed so that each recording column partially overlaps in the radial direction another recording column adjacent relative to the radial direction. In other words, the magnetization pattern in each recording column has a portion relative to the width direction (radial direction) which is overwritten by a recording column formed immediately after. Thus, as shown in FIG. 1A, tracks Tr1, Tr2, Tr3 (later-described non-overlapping portions) . . . are formed sequentially in the direction from the lower portion to the upper portion of the figure. In FIG. 1A and FIG. 1B, the boarder lines and the center lines of the tracks are indicated by dotted lines and dashed lines.

The following describes steps of a process, particularly a recording method, performed in the controller 20.

To form an n-th recording column (n=any given natural number ranging from 1 to N at the maximum) on the magnetic recording medium 3 in the magnetic recording reproducing apparatus 4 of the present embodiment, the controller 20 which controls the suspension 5, the voice coil motor 7, and the recording reproducing head 9 controls formation of the n-th recording column so that the n-th recording column partially overlaps an (n−1) th recording column which is the immediately previous track, in the radial direction.

The controller 20 serving as the magnetic recording element control unit performs control so that a plurality of recording columns are formed at a constant pitch in the radial direction. More specifically, where the radial positions of the inner and outer circumferential edges of the n-th recording column for forming an n-th track are R(n)ᵢₙ and R(n)ₒᵤₜ, respectively, and where the inner and the outer adjacent recording columns of the n-th recording column are an (n−1) th recording column and an (n+1) th recording column, respectively, the controller 20 performs control so as to achieve

R(n−1)ᵢₙ<R(n)ᵢₙ<R(n−1)ₒᵤₜ<R(n+1)ᵢₙ<R(n)ₒᵤₜ<R(n+1)ₒᵤₜ (1).

This leaves at least a radial range from R(n−1)ₒᵤₜ to R(n+1)ᵢₙ as a non-overlapping portion which does not overlap with any of the recording columns, at any given condition. In this non-overlapping portion remains information of the n-th recording column.

This is elaborated below with reference to FIG. 1A and FIG. 1B. To record information in an area where no magnetic information is recorded, a plurality of recording columns are formed so that, starting from formation of the first recording column for forming the first track, the second recording column, the third recording column, . . . are sequentially formed to satisfy the equation (1). This leaves a radial range from R(3)ₒᵤₜ to R(5)ᵢₙ as a non-overlapping portion which does not overlap with any other recording columns. In this non-overlapping portion remains information of the fourth track Tr4. Suppose that R(3)ₒᵤₜ≧R(5)ᵢₙ and that only the recording column for forming the third track Tr3 is rewritten, the information of the fourth track Tr4 is not retained, and the information of the recording column for forming the third track Tr3 overwrites the track Tr4. As the result, the information of the recording column for forming the third track Tr3 is reproduced at the radial position corresponding to the fourth track Tr4, leading to a reproduction error. When the recording column contains a pattern for drawing a PLL (Phase Locked Loop), reproduction error of the pattern for drawing a PLL leads to PLL-drawing error such as generation of wrong clock. To prevent such a reproduction error, the recording column for forming the fourth track Tr4 needs to be overwritten, and the fifth and the subsequent recording columns also need to be overwritten.

However, in the present embodiment,

R(4)ᵢₙ<R(3)ₒᵤₜ<R(5)ᵢₙ<R(4)ₒᵤₜ

Therefore, the information of the fourth track Tr4 is retained in the radial range having a width W(Tr4), which ranges from R(3)ₒᵤₜ to R(5)ᵢₙ. There is no need of overwriting the fifth and the subsequent recording columns. This shortens the total time taken for rewriting, and prevents a decrease in the substantial recording rate.

Supposing that the width of each recording column relative to the radial direction is the same,
if R(n−1)ₒᵤₜ<R(n)ₒᵤₜ, R(n−1)ᵢₙ<R(n)ᵢₙ, and
if R(n)ᵢₙ<R(n+1)ᵢₙ, R(n)ₒᵤₜ<R(n+1)ₒᵤₜ. The equation (1) therefore may be simply expressed as:

R(n)ᵢₙ<R(n−1)ₒᵤₜ<R(n+1)ᵢₙ<R(n)ₒᵤₜ (2).

Similarly, supposing that the width of each recording column relative to the radial direction is the same and the track pitch is the same, the equation (1) may be expressed as follows, using the track pitch W_{Tr}(e.g. R(n)ᵢₙ−R(n−1)ᵢₙ) and the width W_{W} (e.g. R(n)ₒᵤₜ−R(n)ᵢₙ) of the magnetic pattern relative to the radial direction which is formed by the magnetic recording element,

W_{W}/2<W_{Tr}<W_{W} (3)

Since the equation (1) is satisfied in the present embodiment, the information of the n-th recording column is retained in the radial range from R(n−1)ₒᵤₜ to R(n+1)ᵢₙ. Thus, in an area of a magnetic recording medium where no information is recorded, the recording columns do not necessarily have to be formed in a direction from the inner circumference to the outer circumference or in the opposite direction. In other words, it is possible to perform control such that recording columns are formed in a random order.

In the present embodiment, where the width (width of sensing area) of the magnetic reproducing element 11 relative to the radial direction is Wᵣ, the following condition is satisfied:

{R(n+1)ᵢₙ−R(n−1)ₒᵤₜ}>Wᵣ/2 (4).

Suppose the equation (4) is not satisfied. In this case, at the time of reproducing the n-th track Tr (n) after the n-th track Tr (n) is rewritten, the portion of the track Tr (n) retaining information has a width relative to the radial direction, which is less than a half of the width Wr of the magnetic reproducing element 11. Therefore, a half or more of the detected leaked magnetic field could be a component of inter-track cross-talk or the like from adjacent tracks, no matter how the tracking is performed. Such a component may be greater than that from the track to be reproduced.

On the contrary, suppose the equation (4) is satisfied. In this case, at the time of reproducing the m-th track Tr (n) after the n-th track Tr (n) is rewritten, the area retaining information of the track Tr (n) has a width relative to the radial direction, which is wider than a half of the width Wr of the magnetic reproducing element 11. Thus, by tracking the track to be reproduced with the magnetic reproducing element 11, the leaked magnetic field contains less component of the inter-track cross-talk or the like from the adjacent tracks than that from the track to be reproduced. Therefore, reproduction error less likely takes place.

This way, signals from the track to be reproduced is more clearly detected than signals from the adjacent tracks on the inner and the outer circumference sides. It is therefore possible to restrain reproduction errors.

### Modification

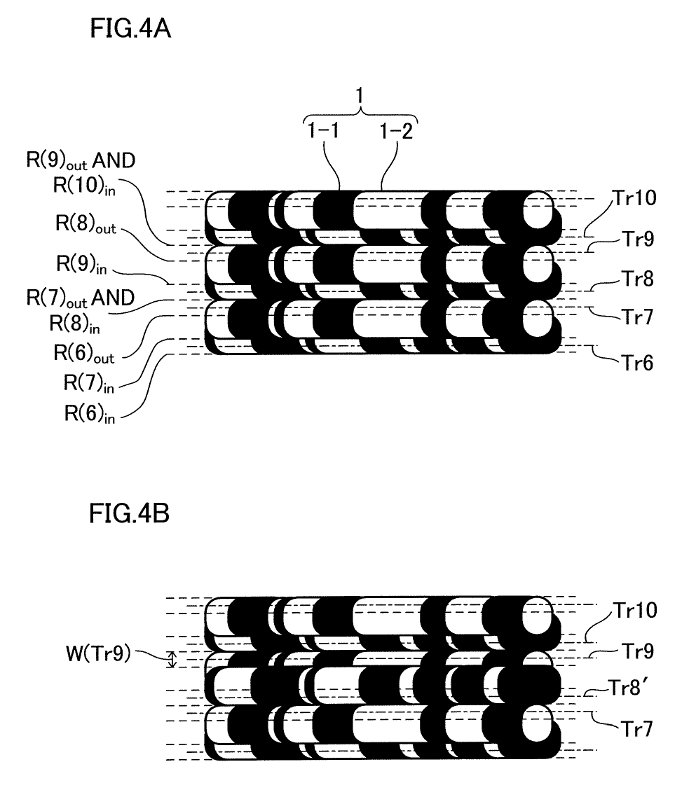

The following describes a modification of the first embodiment. As shown in FIG. 4A and FIG. 4B, in the present modification, a pair of two adjacent tracks (e.g. tracks Tr6 and Tr7) forms, in a radial range from R(7)ᵢₙ to R(6)ₒᵤₜ, an overlapping portion of two recording columns for forming the tracks Tr6 and Tr7, respectively. Further, a radial range from R(6)ᵢₙ to R(7)ᵢₙ, and a radial range from R(6)ₒᵤₜ to R(7)ₒᵤₜ are non-overlapping portions of the two recording columns for forming the track Tr6 and Tr7. Tracks Tr8 and Tr9 are formed in the similar manner, so that R(7)ₒᵤₜ≦R(8)ᵢₙ (in FIG. 4A and FIG. 4B, R(7)ₒᵤₜ=R(8)ᵢₙ). In the present modification, the width W(Tr9) of the track Tr9 is R(9)ₒᵤₜ−R(8)ₒᵤₜ.

As described, by forming the recording columns so that, for each of the recording column, there is an overlapping portion in which adjacent recording columns overlap with each other relative to the radial direction, and a non-overlapping portion in which a recording column does not overlap with any other recording column relative to the radial direction, the information recorded in the non-overlapping portion which does not overlap with any other recording columns (a radial range from R(6)ᵢₙ to R(7)ᵢₙ, a radial range from R(8)ₒᵤₜ to R(7)ₒᵤₜ, a radial range from R(8)ᵢₙ to R(9)ᵢₙ, a radial range from R(8)ₒᵤₜ to R(9)ₒᵤₜ) is retained without being rewritten, even if the information of another recording column is rewritten. For example, in the state shown in FIG. 4A and FIG. 4B, if only the recording column for forming the eighth track Tr8 (Tr8′) is rewritten, that recording column will not rewrite another track, as shown in FIG. 4A and FIG. 4B. Therefore, there is no need of rewriting the other recording columns other than the recording column for forming the eighth track Tr8. Thus, it is possible to prevent a decrease in the substantial recording rate for rewriting operation, even in a magnetic recording reproducing apparatus adopting, as a recording technique, a Shingle technique which allows a dense recording.

### Second Embodiment

Next, a second embodiment of the present invention is described. Parts and members that are identical to those of the first embodiment are given the same reference numerals, and no further description is provided for them.

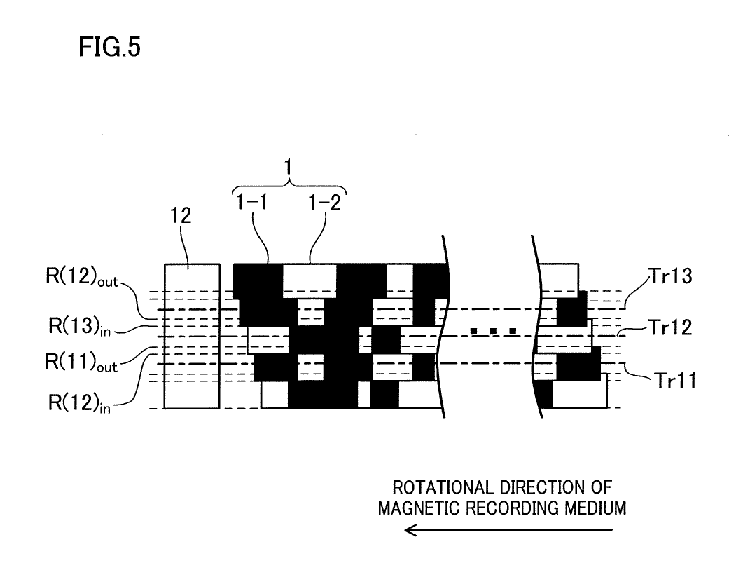

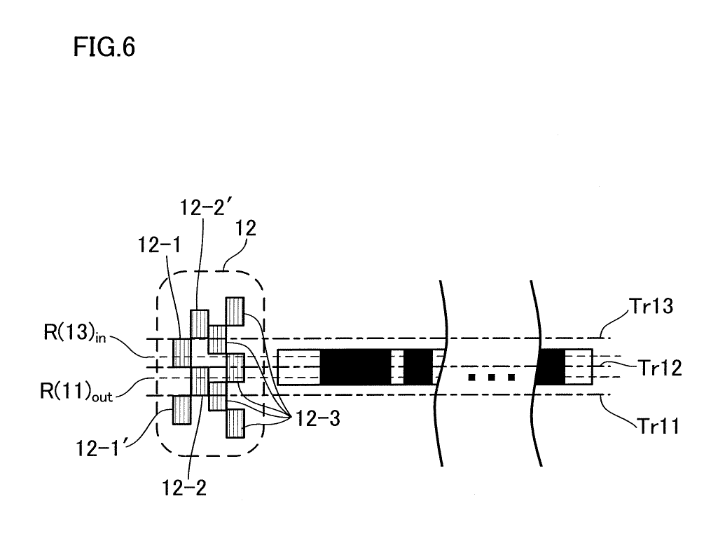

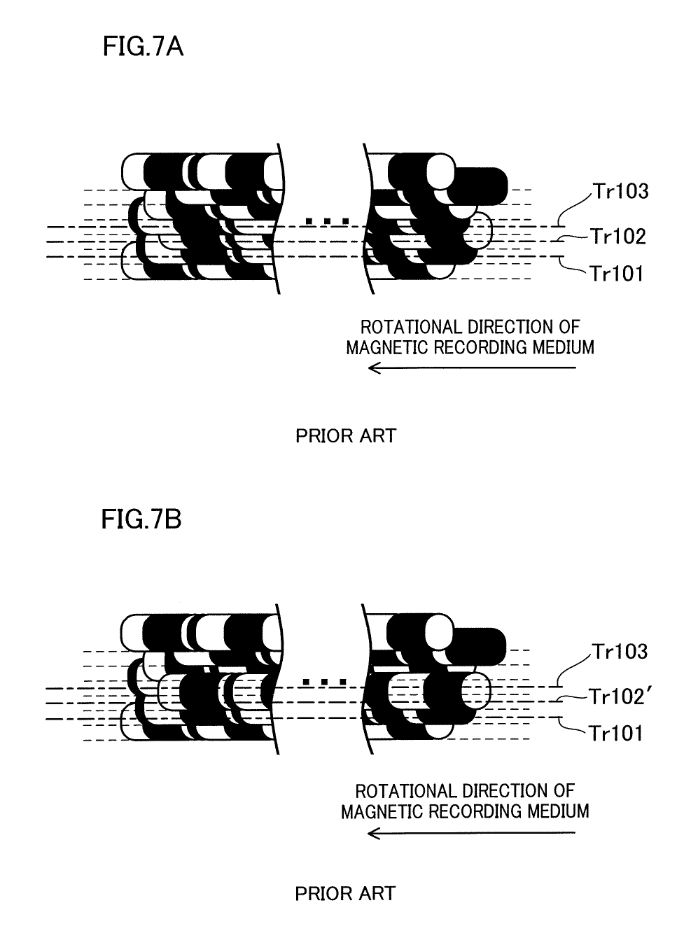

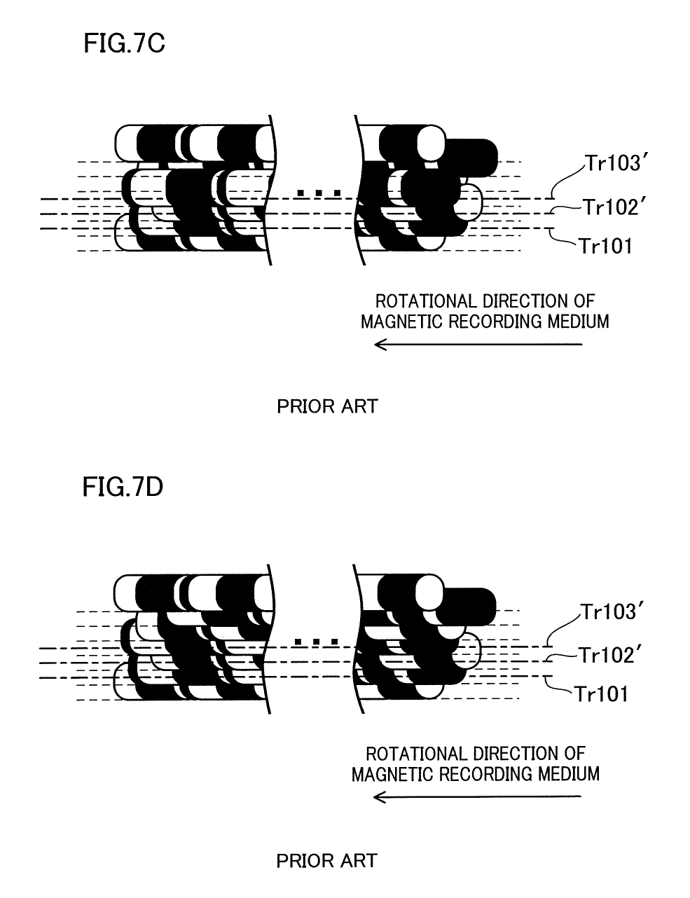

FIG. 5 shows schematically a magnetic recording medium 3 of the present embodiment. FIG. 6 provides a view in which a part of FIG. 5 is enlarged and a part of the same is omitted. As shown in FIG. 5 and FIG. 6, the magnetic recording medium 3 has a tracking pattern 12 (burst pattern) which is a magnetization pattern for tracking each track on the magnetic recording medium 3. The tracking pattern 12 is formed by a servo track writer (STW) or the like in the process of manufacturing the magnetic recording reproducing apparatus 4. The magnetic recording medium 3 before being built into the magnetic recording reproducing apparatus 4 is set to an STW having a magnetic recording head for STW. A magnetic field is then applied to the magnetic recording medium 3, while rotating the same, thus forming a predetermined magnetic tracking pattern 12 on the magnetic recording medium 3. Note that the method of forming the tracking pattern 12 is not limited to the one described above. For example, using a master media storing servo information in advance, the tracking pattern 12 may be formed through magnetic transferring (stamping method). The tracking pattern 12 is formed for each of the recording columns formed on the magnetic recording medium 3, and is reproducible by the magnetic reproducing element 11. Note that, as shown in FIG. 5, the tracking pattern 12 is a group of small patterns (e.g., a group of 12-1 to 12-3).

### Recording Method

The controller 20 serving as the magnetic recording element control unit performs control so that a plurality of recording columns are formed in the radial direction. More specifically, where the radial positions of the inner and outer circumferential edges of the n-th recording column for forming an n-th track are R(n)ᵢₙ and R(n)ₒᵤₜ, respectively, and where the inner and the outer adjacent recording columns of the n-th recording column are an (n−1) th recording column and an (n+1) th recording column, respectively, the controller 20 performs control so that the equation (1) is satisfied. This leaves at least a radial range from R(n−1)ₒᵤₜ to R(n+1)ᵢₙ as a non-overlapping portion, at any given condition. In this non-overlapping portion remains information of the n-th recording column.

To record information in an area where no magnetic information is recorded, a plurality of recording columns are formed so that, starting from formation of the first recording column for forming the first track, the second recording column, the third recording column, . . . are sequentially formed to satisfy the equation (1). In other words, as in the above first embodiment, where the second, third, and fourth tracks are the track Tr1, track Tr2, and track Tr3, respectively as shown in FIG. 5,

R(12)ᵢₙ<R(11)ₒᵤₜ<R(13)ᵢₙ<R(12)ₒᵤₜ.

Therefore, the information on the third track Tr12 is retained at least in a non-overlapping portion which is a radial range from R(11)ₒᵤₜ to R(13)ᵢₙ. When rewriting only the recording column for forming the third track Tr12, there is no need of overwriting the fourth and subsequent recording columns. This shortens the total time taken for rewriting, and prevents a decrease in the substantial recording rate.

### Reproduction Method

The magnetic reproducing element 11 reproduces information by detecting the tracking pattern 12 to specify the radial position of a targeted track on the magnetic recording medium 3, and by performing tracking with respect to the track (radial position). In the present embodiment, the tracking pattern 12 (specifically, later-described small patterns excluding those for distinguishing an even-number-th track from an odd-number-th track) is formed at a track pitch equal to that of tracks.

An inner edge of the small pattern 12-1, and an outer edge of the small pattern 12-2 are both in the center of the track Tr12, i.e., at a radial position expressed as {R(11)ₒᵤₜ+R(13)ᵢₙ}/2. Thus, the radial position of the magnetic reproducing element 11 is controlled so that a signal amplitude detected at the position of the small pattern 12-1 relative to the circumferential direction, and that detected at the position of the small pattern 12-2 relative to the circumferential direction are equal to each other. This enables positioning of the center position Pᵣ of the magnetic reproducing element 11 relative to the radial direction to the center of the track Tr12, i.e., the radial position expressed as {R(11)ₒᵤₜ+R(13)ᵢₙ}/2.

The small patterns 12-3 are patterns for determining whether the track to be reproduced is an even-number-th track or an odd-number-th track. In the present embodiment, signals of the small pattern 12-1 and the small pattern 12-2 are continuously detected prior to reproduction of the track Tr12. After this, if there is a certain interval (an interval equivalent to a single small pattern) before a signal of the small pattern 12-3 is detected, the track Tr12 is determined as to be an odd-number-th track. For example, in cases of Tr11 and Tr13, signals of the small pattern 12-1′ and the small pattern 12-2, or signals of the small pattern 12-1 and small pattern 12-2′ are continuously detected. Then the signal of the small pattern 12-3 is also continuously detected, and no signal is detected thereafter for a certain interval (an interval equivalent to a single small pattern). Therefore, these tracks are determined as to be an even-number-th track.

The tracking pattern is not limited to the above, and the arrangement of the small patterns in the tracking pattern may be different from the arrangement described above. Further, the tracking pattern may be such that tracking is performed based on the phase of signal detected. Further, it is possible to arrange an address pattern storing address information, on or after the tracking pattern.

The center position Pᵣ of the magnetic reproducing element 11 does not necessarily have to be at the center of the track Tr12, i.e., the radial position expressed as {R(11)ₒᵤₜ+R(13)ᵢₙ}/2. By controlling the center position Pᵣ of the magnetic reproducing element 11 to achieve R(11)ₒᵤₜ<Pᵣ<R(13)ᵢₙ, signals from the track Tr12 are more clearly detected than signals from the adjacent track Tr11 and track Tr13, even after the track Tr12 is rewritten. This restrains reproduction errors.

In this case, the inner edge of the small pattern 12-1 and the outer edge of the small pattern 12-2 are positioned in radial positions between R(11)ₒᵤₜ and R(13)ᵢₙ. This way, the radial position of the magnetic reproducing element 11 is controlled so that a signal amplitude detected at the position of the small pattern 12-1 relative to the circumferential direction, and that detected at the position of the small pattern 12-2 relative to the circumferential direction are equal to each other. This enables positioning of the center position Pᵣ of the magnetic reproducing element 11 relative to the radial direction so that R(11)ₒᵤₜ<Pᵣ<R(13)ᵢₙ. Note that, for the purpose of optimizing the reproduction signal quality such as the error rate, according to the signal level, inter-track cross-talk, or noise level, it is possible to electrically offset the radial position of the magnetic reproducing element 11 within a range such that R(11)ₒᵤₜ<P_{r<R}(13)ᵢₙ is satisfied, so that the radial position of the magnetic reproducing element 11 during reproduction is slightly different from the position of the same where the amplitudes of the detected signals from the small pattern 12-1 and the small pattern 12-2 are equal to each other.

Further, the magnetic recording element 10 may form a recording column while the magnetic reproducing element is performing tracking based on the signal detected from the tracking pattern 12. If the center position of a track to be reproduced is different from that of the recording column formed, relative to the radial direction, it is possible to track a radial position different from the position where the amplitudes of detected signals from the small pattern 12-1 and the small pattern 12-2 are equal to each other, by means of electric offset at the time of forming a recording column. This enables tracking when forming the recording columns, by using the tracking pattern 12 corresponding to the radial positions of the tracks. There is no need for an extra tracking pattern for forming a recording column separately from the tracking pattern for reproducing a recording column. As the result, recording error is reduced without a need of reducing the recording capacity.

### Application to Laser (Heat)-Assisted Magnetic Recording Reproducing Apparatus

The present invention is also applicable to a laser (heat)-assisted magnetic recording reproducing apparatus. In this case, the magnetic recording reproducing apparatus has a laser (heat) source for locally heating the recording medium. The recording medium in this case may be a magnetic recording medium having a magnetic recording film whose magnetic switching field is lowered to a desirable level when heated by the laser (heat).

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A magnetic recording reproducing apparatus, comprising:
a disc-shaped magnetic recording medium having thereon an information recording area;
a magnetic recording element configured to perform information recording, by applying a magnetic field to the magnetic recording medium to form recording columns extending in a circumferential direction of the magnetic recording medium;
a magnetic reproducing element, which performs information reproduction by detecting leaked magnetic field from the magnetic recording medium;
a moving mechanism configured to move the relative position of the magnetic recording medium to the magnetic recording element and the magnetic reproducing element, in the circumferential direction and a radial direction of the magnetic recording medium; and
a magnetic recording element control unit configured to control the magnetic recording element and the moving mechanism so that, in the information recording area, recording columns adjacent to each other relative to the radial direction are partially overlapped with each other in the radial direction,
wherein the magnetic recording element control unit performs control so that each of the recording columns has
an overlapping portion which partially overlaps with either of the adjacent recording columns in the radial direction, and
a non-overlapping portion which does not overlap with any of the recording columns in the radial direction.

2. The magnetic recording reproducing apparatus according to claim 1, wherein:
where radial positions of the inner and outer circumferential edges of a first recording column are R1ᵢₙ and R1ₒᵤₜ, respectively, and
radial positions of the inner and outer circumferential edges of a second recording column are R2ᵢₙ and R2ₒᵤₜ, the second recording column being the outer adjacent recording column to the first recording column, and
radial positions of the inner and outer circumferential edges of a third recording column are R3ᵢₙ and R3ₒᵤₜ, the third recording column being the outer adjacent recording column to the second recording column,
the magnetic recording element control unit performs controls so that
R1ᵢₙ<R2ᵢₙ<R1ₒᵤₜ<R3ᵢₙ<R2ₒᵤₜ<R3ₒᵤₜ.

3. The magnetic recording reproducing apparatus according to claim 2, wherein
where a width of the magnetic reproducing element relative to the radial direction is Wᵣ,
(R3ᵢₙ−R1ₒᵤₜ)>Wᵣ/2.

4. The magnetic recording reproducing apparatus according to claim 2, further comprising
a magnetic reproducing element control unit configured to control the magnetic reproducing element and the moving mechanism,
wherein the magnetic recording medium has a tracking pattern, and
at a time of reproducing the non-overlapping portion formed on the second recording column, the magnetic reproducing element control unit controls the magnetic reproducing element and the moving mechanism based on a signal detected from the tracking pattern so that the center position Pᵣ of the magnetic reproducing element relative to the radial direction satisfies
R1ₒᵤₜ<Pᵣ<R3ᵢₙ.

5. A disc-shaped magnetic recording medium comprising an information recording area having a plurality of recording columns extending in a circumferential direction, wherein
each of the recording columns has
an overlapping portion which partially overlaps with either of the adjacent recording columns in a radial direction, and
a non-overlapping portion which does not overlap with any of the recording columns in the radial direction.

6. The magnetic recording medium according to claim 5, wherein
where radial positions of the inner and outer circumferential edges of a first recording column are R1ᵢₙ and R1ₒᵤₜ, respectively, and
radial positions of the inner and outer circumferential edges of a second recording column are R2ᵢₙ and R2ₒᵤₜ, the second recording column being the outer adjacent recording column to the first recording column, and
radial positions of the inner and outer circumferential edges of a third recording column are R3ᵢₙ and R3ₒᵤₜ, the third recording column being the outer adjacent recording column to the second recording column,
R1ᵢₙ<R2ᵢₙ<R1ₒᵤₜ<R3ᵢₙ<R2ₒᵤₜ<R3ₒᵤₜ.
